(19) United States
(12) Patent Application Publication
(10) Pub. No.: US 2006/0010023 A1
(43) Pub. Date: Jan. 12, 2006

(54) System, method and computer program product for managing meeting planning operations

(75) Inventors: Edward J. Tromczynski, Hudson, OH (US); Anthony J. Stanfar, Strongsville, OH (US)

Correspondence Address: HAHN LOESER & PARKS, LLP, One GOJO Plaza, Suite 300, AKRON, OH, 44311-1076, US

(73) Assignee: On Vantage, Inc.

(21) Appl. No.: 11/085,794

(22) Filed: Mar. 21, 2005

Related U.S. Application Data
(63) Continuation of application No. 09/963,911, filed on Sep. 26, 2001, now abandoned.
(60) Provisional application No. 60/237,284, filed on Oct. 2, 2000.

(51) Int. Cl. G06F 17/00

(52) U.S. Cl. 705/8

(57) ABSTRACT

Systems, methods and computer program products are provided for planning meetings or conferences. The present invention establishes methods and procedures to define, organize, share, maintain and report essential information especially financial information associated with an individual meeting or a collection of meetings especially the collection of all of a particular organization's meetings. Essential meeting information includes but is not limited to Meeting Logistics, registration, and financial information. The methods and procedures involve a meeting planner gathering information in the various stages of planning a meeting, utilizing the information to plan that stage of the meeting then consolidating the information to manage other aspects of the meeting and to produce reports, especially financial reports, about the meeting then consolidating the meeting information with information about other meetings to produce organization-wide reports, especially financial reports, about all an organization's meetings. The present invention also provides methods and procedures for utilizing consolidated meeting information for business advantage.

This application is a continuation of U.S. application Ser. No. 09/963,911 filed on Sep. 26, 2001 which claims benefit of U.S. Provisional Application No. 60/237,284 which was filed on Oct. 2, 20000.

### TECHNICAL FIELD

The present invention relates generally to planning meetings and conferences. More particularly, the present invention relates to methods for managing meeting information, especially financial meeting information, to support financial decision making in large organizations.

### BACKGROUND OF THE INVENTION

In the past decade, while corporations and other organizations made great strides controlling supply chain costs through more intelligent spending, one area that eluded effective cost control was meetings. Organizations found no obvious way to consolidate the various costs associated with meetings in meaningful ways to support the organization's efforts to take actions such as consolidating suppliers, centralizing expenditures, establishing organization-wide contracts with suppliers, negotiating preferred pricing with suppliers based on total company spend, utilizing space available as a result of attrition or cancellation, and avoiding scheduling conflicts. Effective processes to accomplish these initiatives remained elusive, in part because means for achieving universal participation in gathering the necessary information are difficult to establish. Organizations were unable to consolidate meeting planning so that work processes could be controlled and financial information could be consolidated. Methods to control meeting planning costs and processes distributed throughout an organization were not available.

During the same time period, most of the financial information related to meetings was, and often still is, ‘owned’ and maintained locally by meeting planners in the form of spreadsheets or other documents. A variety of tools appeared designed to aid meeting planners with activities such as requests for proposals, meeting logistics, registration, and travel bookings. Initially, these tools were provided for personal computers and, more recently, via the Internet with its superior information distribution capabilities. To manage all the aspects of meeting planning and track all the financial aspects of meetings, a meeting planner needed a variety of these tools. Some of these tools provided financial management capabilities while others did not. However, even when financial management capabilities were provided, the various tools remained stand alone products making it impractical to gather the financial information from the various planning tools for consolidated or historical financial reporting in support of company-wide financial decision making.

As a result, the financial information about meeting spending needed by large organizations to take advantage of their substantial buying power remained scattered among the various divisions and software applications within these organizations.

Therefore, in light of the foregoing deficiencies in the prior art, the applicant's invention is herein presented.

### SUMMARY OF THE INVENTION

In view of the foregoing, it is an object of the present invention to facilitate the planning and organization of meetings and/or conferences.

Another object of the present invention is to provide a process to consolidate and summarize organizations' meeting information to support organization-wide financial decision making.

Another object of the present invention is to provide a process to consolidate and summarize meeting information required by meeting planners for planning a meeting.

Another object of the present invention is to provide a process to consolidate and summarize meeting information required by meeting attendees.

Another object of the present invention is to provide a process to consolidate and summarize historic meeting information to support financial and planning decisions.

Another object of the present invention is to provide processes to promote the use of meeting information consolidation processes.

Another object of the present invention is to provide a process to consolidate and summarize meeting information gathered by the various meeting planning tools.

Another object of the present invention is to provide a long term process for holding past meeting data and data about recurring meetings for future budget planning and fund raising.

Another object of the present invention is to provide a process to avoid and resolve scheduling conflicts.

Another object of the present invention is to better utilize existing meeting planner resources by tracking the activities of meeting planners within an organization.

Another object of the present invention is to provide a process to enable organizations to avoid losses due to attrition or meeting cancellation and to take advantage of opportunities to reduce meeting costs.

In order to achieve the objectives described above, there is herein provided a system, method and computer program product for managing meeting planning operations. A computer system in accordance with the present invention comprises at least one input device, at least one display and at least one processor. The computer system also comprises a means for receiving data to identify a meeting, which can be done through the input device. The system also includes a means for receiving meeting scheduling data. The scheduling data may come through the input device as entered by a user of the system or it may be imported from an electronic calendar that is a part of the system. The system also has a means for data regarding resources required for a meeting and a means for generating a request for proposal to send to a supplier of the resource. The system additionally comprises a means for receiving a proposal a supplier and incorporating that data into the system. Another aspect of the invention is a means for tracking the request for proposals and proposal data received from suppliers. Further, the system comprises a means for creating a budget for the meeting and a means for receiving financial data for the meeting. The financial data can be reconciled with the budget. The system may also comprise a means for receiving registration data for the meeting. All of the information and data can be stored by the system and reports can be generated based on the stored data.

A computer program product in accordance with the present invention comprises computer usable medium having computer readable program code configured to cause a computer to receive input defining parameters for a meeting, to define required resources for a meeting, to request proposals from resource suppliers, to receive proposals from suppliers, to generate a budget, to forecast costs for the meeting, to receive financial data such as actual costs or income, to compare the budget, forecasted costs and actual cost data and to store all of the above information on the computer. Parameters for a meeting may comprise dates and times for meetings and events, the destination or venue of the meeting, travel times, and other scheduling information as is described herein. The computer readable program code may also be configured to cause a computer to generate a report based on data collected and generated by the computer program.

A method in accordance with the present invention involves the steps of receiving scheduling data for a meeting, creating a budget for the meeting, receiving data related to a required resource for the meeting, generating a request for proposal for provision of a required resource, receiving a proposal from a supplier to provide the required resource, importing data from the proposal into the budget, collecting financial data for the meeting, importing said financial data into said budget; and reconciling the financial data, the proposal data and the budget. The method also includes the step of storing all of the above stated information.

The details of the present invention will become more readily apparent from a reading of the detailed description taken in conjunction with the drawings and the claims.

### BRIEF DESCRIPTION OF THE DRAWINGS

FIG. 1A is a flowchart illustrating an overview of the method for planning meetings from a planning perspective;

FIG. 1B illustrates a user interface for entering information into the meeting planning system in accordance with the present invention;

FIG. 1C illustrates a meeting planning calendar feature;

FIG. 2A is a flowchart illustrating an overview of the method for planning meetings from a financial perspective;

FIG. 2B illustrates a sample budget user interface in accordance with the present invention;

FIG. 3 is a chart illustrating the sources of information and users of consolidated reports produced by the meeting planning system of the present invention.

### DETAILED DESCRIPTION OF THE PREFERRED EMBODIMENT

The present invention is fully described hereinafter with reference to the drawings, in which preferred embodiments of the invention are shown. The invention may also be embodied in many different forms and should not be construed as limited to only the disclosed embodiments. The provided embodiments are included so the disclosure will be thorough, complete and will fully convey the scope of the invention to persons of ordinary skill in the art.

A person of ordinary skill in the art would appreciate that the present invention may be embodied as a method, data processing system, or computer program product. As such, the present invention may take the form of an embodiment comprised entirely of hardware; an embodiment comprised entirely of software or an embodiment combining software and hardware aspects. In addition, the present invention may take the form of a computer program product on a computer-readable storage medium having computer-readable program code means embodied in the medium. Any suitable computer readable medium may be utilized including hard disks, CD-ROMs, optical storage devices, or magnetic storage devices.

The present invention is described with reference to flowcharts and/or diagrams that illustrate methods, apparatus or systems and computer program product. It should be understood that each block of the various flowcharts, and combinations of blocks in the flowcharts, can be implemented by computer program instructions. Such computer program instructions can be loaded onto a general-purpose computer, special purpose computer, or other programmable data processing device to produce a machine, such that the instructions that execute on the computer or other programmable data processing apparatus create means for implementing the functions specified in the flowcharts. The computer program instructions can also be stored in a computer-readable memory that directs a computer or other programmable data processing device to function in a particular manner, such that the instructions stored in the computer-readable memory produce an article of manufacture including instruction means which implement the function specified in the flowcharts or diagrams. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowcharts or diagrams.

It will be understood that blocks of the flowcharts support combinations of means for performing the specified functions, combinations of steps for performing the specified functions and program instruction means for performing the specified functions. It is also to be understood that each block of the flowcharts or diagrams, and combinations of blocks in the flowcharts or diagrams, can be implemented by special purpose hardware-based computer systems which perform the specified functions or steps, or combinations of special purpose hardware and computer instructions.

The present invention could be written in a number of computer languages including, but not limited to, C++, Basic, Visual Basic, Fortran, Cobol, Smalltalk, Java, HTML, XML and other conventional programming languages. It is to be understood that various computers and/or processors may be used to carry out the present invention without being limited to those described herein such as an IBM or IBM-compatible personal computer, preferably utilizing a MICROSOFT DOS, Windows 3.1, Windows 95/98, Windows 2000, or Windows NT, or other operation systems such as Unix, Linux, or the IBM OS/2 operating system. However, it should be understood that the present invention could be implemented using other computers and/or processors, including, but not limited to, mainframe computers and mini-computers and other microcomputers utilizing operating systems not herein enumerated.

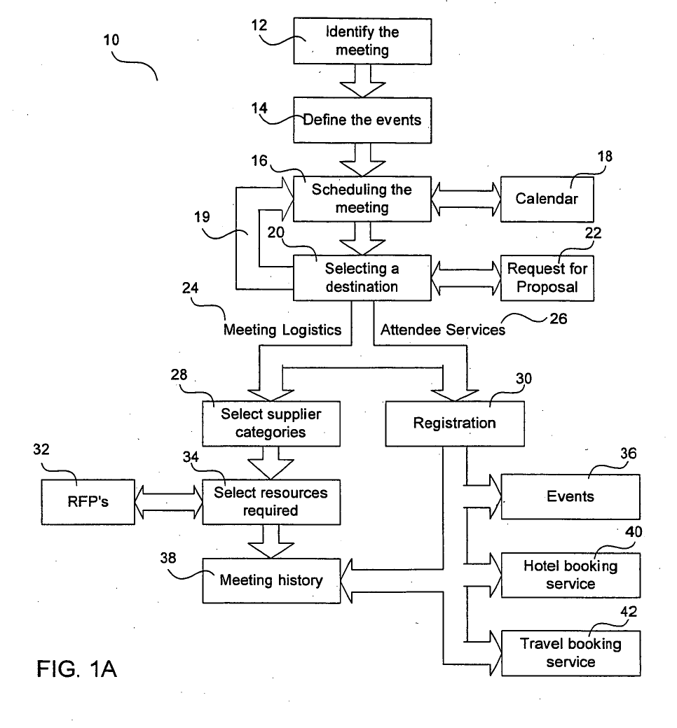

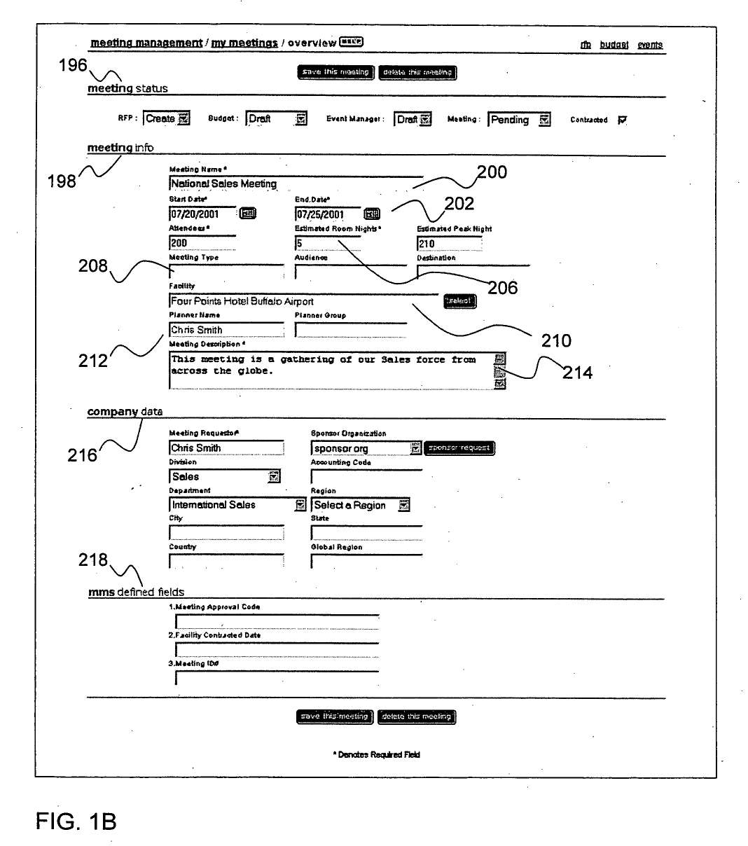

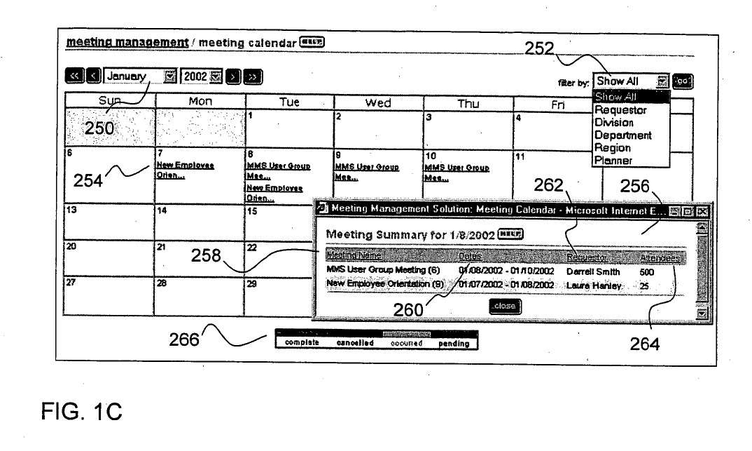

Referring now to FIG. 1, an overview of the meeting planning system, method and computer program product of the present invention, generally designated 10, is displayed showing the steps in the process of planning a meeting. A meeting is an event, conference, convention, exposition, tradeshow, party, reception, congress or other gathering of people at a specific location or several locations for a period of time that may range from an hour or less to many days for the purpose of sharing information. A meeting may consist of numerous individual sessions (referred to as “events”) comprising some or all of the people attending the meeting.

When setting out to plan a meeting, a meeting planner must first identify the meeting 12. In the context of the following discussion a meeting planner is an individual who plans a meeting or a team of individuals that plan a meeting which may include a supervisor or support staff. The identification of the meeting 12 involves defining parameters for the meeting as is described herein by entering, inputting or importing dynamic meeting data into the system. One step in the identification process is assigning a name to the meeting in the system. When identifying a meeting 12 a meeting planner also identifies the organizations responsible for the meeting. One type of organization responsible for a meeting is the owning organization, which may be an association, corporation, or a division within an organization that provides the funding for the meeting and therefore holds the ultimate decision making authority for the meeting. Another type of organization responsible for a meeting is a planning organization which may be the owning organization or an independent organization that specializes in meeting planning. Another type of organization responsible for a meeting is a supplier which provides products or services for the meeting. Another type of organization responsible for a meeting is a sponsoring organization which provides funding, services, or products for the meeting at little or no charge or in exchange for recognition, representation or other intangible consideration. Generally, no more than a few suppliers and sponsoring organizations are identified at this early stage of identifying the meeting 12. The remainder of the suppliers and sponsoring organizations are identified in the course of planning the meeting as described further herein.

When identifying a meeting 12 a meeting planner also identifies the various individuals, groups of people or organizations which may be a company (“generally referred to as ‘people’”) responsible for the meeting. The people a meeting planner identifies include the meeting planners who are responsible for coordinating all aspects of the meeting, the owners who requested the meeting and are part of the owning organization, supplier contacts who are employees or members of a supplier, sponsors who are contacts within the sponsoring organization, and attendees. Attendees are comprised of exhibitors who often pay a fee to present their products and services at the meeting, presenters who conduct any of the various sessions at a meeting, and participants who sometimes pay a fee to attend expecting to gain some value from the meeting. Generally, no more than a few supplier contacts, sponsors or attendees are identified at this early stage of identifying the meeting 12. At this stage, attendees may be identified in general terms, such as the departments or divisions involved.

Once a meeting planner has identified a meeting 12, the meeting planner defines the events for a meeting 14. Events are also part of the dynamic meeting data and meeting parameters which must be defined. An event is any scheduled, self-contained, activity in a meeting that requires an allocation of time and space or other resources. To define the events for a meeting 14 a meeting planner identifies the name, the start and end dates, the start and end times, the location, the room space requirements such as the room dimensions and setup, the expected number of attendees, and the people responsible for each event as well as any other requirements that effect scheduling of meeting space or other resources for each event.

Once a meeting planner has defined the events for a meeting 14, the meeting planner schedules another parameter, the meeting dates 16. To schedule a meeting 16, the meeting planner opens the organization's meeting calendar 18 and blocks the date range for the meeting on the calendar. Depending on the importance and scheduling flexibility of the meeting, a meeting planner blocks a single date range or several date ranges and assigns a tentative or a definite priority to the date ranges. The priorities do not prevent other meetings from being scheduled in the meeting planning system during the same date ranges, but, alert other meeting planners to potential conflicts. It is valuable when scheduling a meeting to identify the key attendees for the meeting and to identify all attendees in general terms, such as the departments or divisions involved, so other meeting planners can avoid scheduling conflicts or can at least alert the affected attendees and meeting planners if a conflict cannot be avoided.

Once a meeting planner has scheduled a meeting 16, the meeting planner selects another part of the dynamic meeting data, which is the destination for the meeting 20. Destinations are geographically separate locations, typically cities, where a meeting can be held. To select a destination for a meeting 20 a meeting planner conducts a search for suitable venues against a database contained in the meeting planning system. A venue is a conference center, convention center, hotel, restaurant, theater or other site or combination of any of these where a meeting or events are held. When selecting a venue, a meeting planner takes into account the availability of suitable meeting space, the number of available guestrooms, the quality of the venue and a variety of other factors. Naturally, cost is a major factor in selecting a destination. To assist the meeting planner in evaluating costs an organization includes various rates for guest rooms and meeting rooms in the meeting planning system. Rates for guests room and meeting rooms an organization displays in the meeting planning system include: preferred rates negotiated with a venue, distressed rates for unsold space a venue is trying to fill, standard rates sometimes called “rack rates”, averages rates, seasonal rates, rates for the specific dates the meeting is scheduled or any other special rates or standard rates offered by a venue.

The meeting planning system displays internal meeting space and guest rooms available in buildings owned by the planning organization or the owning organization and displays rates if the organization charges individual departments for the use of internal meeting space or guest rooms. The meeting planning system displays cancelled guest rooms and meeting space that were booked for meetings that were later cancelled. The owning organization generally has to pay a penalty for canceling guest rooms and meeting space unless another meeting can be booked in the same time slot. Display of the cancelled guest rooms and meeting space in the meeting planning systems makes other planners aware of the cancellation and fill the cancelled guest rooms and meeting space with new meetings. The system stores the information regarding cancelled meetings for these purposes.

Other types of suppliers set prices based on a meeting planners choice of destination. Airlines are an especially noteworthy type of supplier that has destination specific pricing. The meeting planning system displays rates for suppliers that have destination dependant pricing. Supplier rates included in the meeting planning system include, but are not limited to: preferred rates negotiated by the meeting planners organization, distressed rates, list prices, averages rates, seasonal rates, or rates for the specific dates the meeting is scheduled.

An organization may choose to display or highlight only certain rate categories, such as coach air fares, or display or highlight only certain venues and suppliers, such as preferred venues and suppliers, to require or encourage meeting planners to use these rate categories or these preferred venues and suppliers. Alternatively, a organization may permit a meeting planner to add venues and suppliers to the meeting planning system database. An organization may elect to make venues and suppliers which a meeting planner adds to the meeting planning system available for all meetings or only for the meeting planner's individual meeting.

Once a meeting planner has identified several suitable venues at one or more destinations the meeting planner sends the scheduling, meeting space, and housing requirements for the meeting and the events comprising the meeting to the venues often in the form of a document referred to as a “request for proposal” or “RFP” 22. The responses to the RFPs 22 from the venues provide the information the meeting planner will use to finalize its selection of items such as the destination 20, date range and one or more venues for the meeting.

Once a meeting planner has selected a destination 20, and in the process confirmed the availability of guest room and meeting space at the meeting planner's chosen venues, the meeting planner converts a tentative date range on the organization's meeting calendar 18 to a definite date range as shown by a broken arrow 19 connecting the Destination Selection 20 with scheduling the meeting 16. The meeting planning system deletes any other tentative date ranges for the meeting.

Depending on the preferences of people in the planning organization, owning organization, meeting planner, and the requirements and complexity of a meeting, a meeting planner may complete the steps of defining the events for the meeting 14, scheduling the meeting 16, and selecting a destination for the meeting 20 in any order or these steps may be completed in an iterative or ‘leap frog’ sequence.

It is convenient to discuss the remainder of the meeting planning process as two separate processes, Meeting Logistics 24, and Attendee Services 26. Meeting Logistics 24 involves coordination of suppliers 32 and the delivery of all the resources 34 the suppliers 32 will provide to a meeting. Attendee Services 26 involves coordination of all the services that enable attendees to participate in a meeting including; registration 30, hotel booking 40 and travel booking 42. Although Meeting Logistics 24 and Attendee Services 26 will be discussed separately, the meeting planning system shares a great deal of information between the two processes. Each process will now be described and explained in detail.

Beginning with Meeting Logistics 24, once a meeting planner defines the events for a meeting 20 the meeting planner selects the supplier categories 28 that are appropriate to the meeting and events. Standard categories used in the meeting planning industry are numerous. Examples include, but are not limited to food and beverage, meeting room rental, guest room rental, audio-visual equipment rental, equipment rental, printing, advertising, air travel, car rental, insurance, staffing and a variety of other categories. Products and services for some of these categories are typically provided by the owning organization or planning organization. The meeting planning system provides these and other supplier categories 28 as standards and provides the functionality to add additional supplier categories 28 if needed by an organization for a particular meeting. The supplier categories 28 identify the general kinds of resources required for a meeting. The process of selecting supplier categories 28 from a collection of standard categories provides a standard model for meeting planners to use in managing and organizing Meeting Logistics. The supplier categories also provide a framework for managing meeting finances which will be described later. Ideally, a single supplier 32 will provide all the resources required for a supplier category, but, multiple suppliers 32 for a supplier category 28 may be designated in the meeting planning system.

Once a meeting planner has selected the supplier categories 28, the meeting planner selects the resources required 34 in each supplier category for each event. The meeting planner defined events 14 for the meeting in the meeting planning system earlier in the meeting planning process so the meeting planner does not need to re-enter the events. Selecting supplier resources 34 is similar to selecting a destination 20. The resource requirements for a meeting are provided to one or more suppliers in an RFP 32 for each category. A meeting planner chooses one or more suppliers for each supplier category based on suppliers' abilities to provide the desired specific resources the meeting planner designated for the meeting. Alternatively, a meeting planner may choose a supplier based on other criteria, such as preferred supplier status, and select specific resources for the meeting from the supplier's available resources. As noted for the process of selecting a destination 20, the meeting planning system displays suppliers of meeting products and services that may be limited by the meeting planner's organization to preferred suppliers only.

The meeting planning system also provides a means for a meeting planner to track RFPs 22 sent to and replies received from venues and suppliers 32. The tracking process provides a schedule for each category which includes the date RFPs 22 should be sent to a venue or other supplier, the date the RFP 22 was actually sent, the date responses are due from venues or other suppliers, the date a decision will be made and a mechanism to remind the meeting planner when each of these dates approaches. The tracking or communications portion of the invention in conjunction with the proposal processing unit tabulates the RFP responses from the venues 22 and suppliers 32 within each category and allows the meeting planner to designate the selected venues and suppliers from the responses received. The tracking system may also prompt the planner to send a reminder to a venue or supplier who has not yet responded to the RFP. The communications unit also allows data and information to be shared among the various features of the present invention.

The planning process for Attendee Services 26 will now be described and explained in detail. An attendee expresses interest in attending a meeting through the process of registration 30. Registration can be carried out through a registration unit of the planning organization, through a computer program or by a method as described herein. Registration may take place by a potential attendee accessing a web site or contacting a planning organization by some other means. It is contemplated by the present invention that attendees may register online electronically, by phone or by submitting appropriate papers to a planning organization.

Attendees fall into several groups based on the attendees role in the meeting, including, but not limited to exhibitors, presenters, participants and others. Meeting planners use the registration process to gather the information about each attendee such as name, title, employer, address, telephone number, facsimile number, electronic mail address, membership number, role in the meeting and sometimes demographic information of interest to the owning or planning organization.

In addition to registering attendees for the meeting as a whole, a meeting planner may require attendees to register 30 for individual events 36 such as meals, seminars, product demos, recreational activities such as tours or excursions, and other activities. Since the meeting planner previously defined the events for the meeting 14 in the meeting planning system, there is no need to re-enter the events for the registration process 30. Unless a meeting is local for all the attendees, some attendees may require a hotel room in order to attend the meeting. To accommodate attendees' needs for hotel rooms during a meeting, the meeting planning system provides a hotel booking service 40 as part of the registration process 30. To accommodate attendees' transportation needs the meeting planning system provides travel booking services 42 for air travel, ground transportation such as rental cars or chartered limousines, and other transportation needs. The hotel booking and travel booking services may be coordinated through third party organization such as a travel agency or GDS or directly with the hotel (venue) or transportation supplier. A GDS is an company that processes booking transactions for a variety of venues, airlines, and ground transportation companies to support travel agents and other travel companies and provides little in the way of consumer services.

Prior to the meeting, all of the described information is stored within the system. Following a meeting, a meeting planner generally retains all or portions of the information about the meeting. Such stored information is collectively referred to as “history” 38. History 38 is particularly valuable for recurring meetings such as annual conventions because the information from previous meetings can be used to aid in planning future meetings. Information retained in history 38 is diverse. Some examples of information retained in history 38 include attendance at events, spending by category, attendee lists, registration forms, and other data, information, and documents. Often, however, a meeting planner does not retain this information or the responsibility for a recurring meeting is transferred to a new planner who does not have access to the original planner's history 38. The meeting planning system ensures that meeting history 38 is collected retained and made available to individuals who need it.

FIG. 1B and 1C illustrate portions of the meeting planning system of the present invention. FIG. 1B shows an example of a computerized interface used to enter, modify, and/or display meeting identification and scheduling information. The interface allows a user to enter or select information such as meeting status 196, meeting description information 198, company data 216 for the meeting planning organization. Other fields 218 may also be defined for keeping track of organization specific codes, such as approval codes, account numbers and identification numbers. The interface shows the status 196 of various aspects of the meeting planning process, such as RFP's, budgets, events, and the meeting as a whole. Identifying information for a meeting 198 is also displayed on the interface. Information such as meeting name 200, the starting and ending dates of meeting 202, the attendance for the meeting 204, the estimated number of room nights and/or rooms needed 206, the type of meeting 208, the facility where the meeting will be held 210 the name of the planner 212 and any descriptive information about the meeting 214. The meeting information which can be entered into or displayed on the interface is not limited to the above examples. The information described above can be typed into the system, selected from drop down or other menus, or imported into the interface by the tracking system associated with the present invention.

The interface can also show data about the company holding the meeting 216. This information may include, but is not limited to the name of the person requesting the meeting or supervising the planning of the meeting, the name of the organization sponsoring the meeting, the division and/or department of the organization to which the meeting is directed, regions or locations where the division or department or meeting is located, or organization accounting codes assigned to a particular meeting.

FIG. 1C illustrates a meeting calendar used in association with the meeting planning system of the present invention. The meeting calendar can specify an increment of time for which it applies 250, such as a month, week, day or year. The calendar shows a meeting and/or events planned or tentatively planned for a particular day, as shown by the example indicated by reference numeral 254. The meeting or event 258 shown on a block of the calendar can be provided in hyperlink text. This allows the title on the calendar to be linked to detailed information about the meeting or event 256. A user may click on the calendar link 254 for a particular meeting, and have a separate window or jump to a separate page where more specific information about the meeting is displayed, such as the dates for the meeting 260, a responsible person's name 262, and the number of attendees for the meeting 264. The meeting specifics mentioned above are provided by way of example only and should not be limiting of any information which may be provided about a meeting or event through a link. The calendar can also comprise a status indicator 266 for a particular meeting or events on the calendar, for instance showing whether a meeting is complete, cancelled, has occurred or is pending.

Another tool available for use with the calendar allows the user to limit the information presented on the calendar. The filter 252 feature consists of a drop down menu which allows a user to select the information shown on a particular calendar display. All information may be shown or only meetings for a particular requester or planner, a specific division, department or regions. It is contemplated by the present invention that other means for dividing the calendar information may also be used.

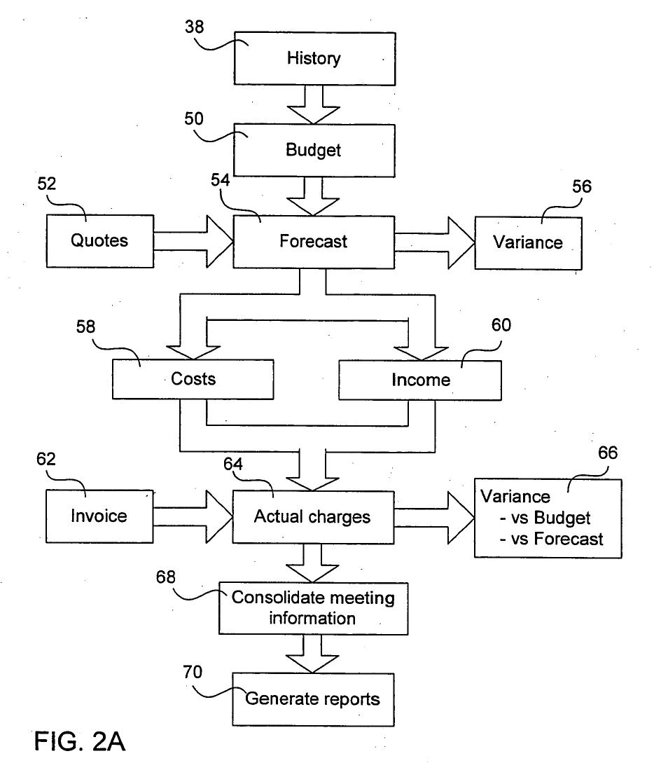

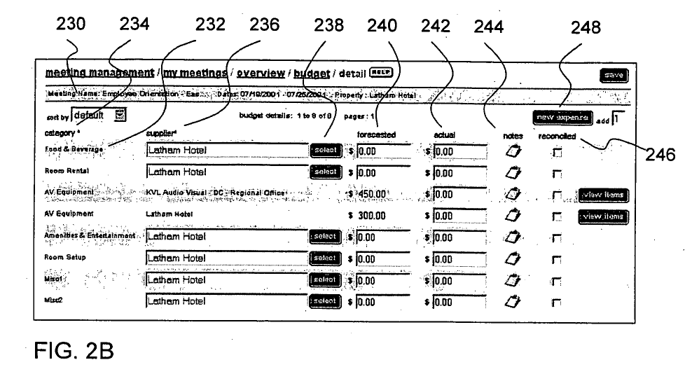

Referring now to FIG. 2A, the financial aspects of planning a meeting using the meeting planning system will now be described and explained in detail with reference to the meeting planning process illustrated in FIG. 1A. The financial aspects of managing meeting planning operations in the present invention may be conducted by a budget unit that is part of a meeting planning system, a computer program product which provides instructions to a computer to perform budget manipulations or a method carried out using a computer. Dynamic financial data as used in the system, method or computer program product of the present invention consists of proposed or actual costs for resources as well as income. The dynamic financial data may be comprised of any monetary amount used by or under the control of the meeting planner that relates to the conduct of the meeting. This financial data includes quotations for the provision of goods and services, actual charges, costs, taxes, gratuities, service charges, income, complementary goods or services, cost or charge forecasts, and variances among the financial data. Items such as taxes and gratuities are generally included under the general heading of costs, because they are paid out by the organization. However, if these or other items such as service charges or gratuities are not paid by the organization, then the items would not be included in the cost categories. The financial data may also consist of the spending data or expenditures of an organization for one particular meeting or for a plurality of meetings from a single meeting to all of the meetings owned or planned by a particular organization. The dynamic financial data may also be used in generating reports regarding the meeting.

A meeting planner begins the process of managing the financial aspects a meeting by creating a budget 50. A meeting planner generally prepares a budget from the history 38(FIG. 1A) of a past meeting, the present meeting or using data from a similar meeting. A budget consists of two general parts, income 60 and costs 58, except in cases where a meeting does not generate income 60. Income 60 consists of funds received from sponsors, attendees, particularly exhibitors and participants, sales, particularly concessions, and interest income.

To permit effective management of meeting costs 58, meeting cost categories are defined which correspond to supplier categories 28. Meeting costs 58 may be fixed or variable. Fixed meeting costs typically do not change with attendance. Variable meeting costs usually do change with attendance. The present invention is particularly effective for managing variable meeting costs, as is explained herein.

The meeting planning system generates a budget 50 based on history 38 (FIG. 1A). Since meeting planners often schedule meetings several years in advance, the meeting planning system projects income and costs several years into the future using either a linear or exponential projection and factoring changes in the inflation rate, obtained estimates from financial service companies or financial publications, and trends in attendance from history 38 into the projections.

After completing a budget 50 for a meeting, a meeting planner proceeds to gather other financial data including quotes or proposals 52 in order to forecast 54 costs for the various costs categories. Referring to FIG. 1A, a meeting planner obtains quotes as responses to RFPs 22 sent to venues when selecting a destination 20 and from suppliers 32 when selecting resources required 34 for a meeting. The responses are received or entered into the proposal processing unit or portion of the system, method or computer program product of the present invention. The budget portion of the meeting planning system calculates and displays the variance 56 of the forecast 54 from the budget 50 to identify potential cost overruns or surplus. A meeting planner then adjusts the meeting plans to eliminate the cost overruns or to reallocate surplus if necessary.

Once a meeting planner has received the quotes 52 for products and services for a meeting, the meeting planner proceeds to select a destination 20 or select resources required 34 (FIG. 1). Following the selection process the meeting planner places orders with suppliers 32 and begins to incur costs 58. The meeting planner also begins the registration process 30 then begins to receive income 60.

An owning organization or planning organization may choose to manage costs 58 and income 60 at one of two levels; the meeting level or the event level. Each of these options will now be described and explained in detail. Beginning with the first option, when an organization chooses to manage costs and income at the meeting level, the costs are broken down into the cost categories for the entire meeting. A meeting planner also manages suppliers 32 (FIG. 1A) at this level. The same financial information a meeting planner needs to select a destination 20 and select the resources required 34 for a meeting is needed to create a forecast 54. As a result, the tracking system previously described for managing RFP responses from venues 22 and suppliers 32 also gathers the quotes needed to prepare a forecast 54 and calculate variance 56. Therefore, when an owning organization or planning organization provides the meeting planning system with the tracking tool for RFP responses 22, 32 to its meeting planners, it gives the meeting planners an incentive to use a system that will also gather financial information the organization requires about all the organization's meetings.

The second option an organization may choose for managing costs 58 and income 60 is at the event level which will now be described and explained in detail. When an organization chooses to manage costs 58 and income 60 at the event level, costs 58 and income 60 are broken down into the categories for each event within the meeting. Some of the income 60 collected at the event level comes from sponsoring organizations that sponsor one or more events. Another source of income at the event level is the attendees that register 30 for events 36 for which a fee is charged. As a result, the registration 30 process in the meeting planning system is another tool for meeting planners that collects financial information, in this case income 60 information, for an organization at the event level just as the RFP 22 tracking tool collected cost 58 information for the organization at the meeting level. However, some income 60, such as registration fees for the meeting as a whole, is not collected at the event level. Therefore, the meeting planning system provides methods to distribute meeting income 60 based on; event attendance, a flat percentage per event, attendance for the day and other means.

When a meeting planner manages costs 58 at the event level the meeting planner finds that costs 58, like income 60, are differentiated in that they are sometimes incurred at the event level and sometimes at the meeting level. Examples of costs 58 that are typically incurred at the event level are charges for room setup, catering, speakers, and any other resources needed only for a single event. Examples of costs 58 that are typically incurred at the meeting level are charges for meeting room rental, audio visual and equipment rental, destination management services and other services that support more than one event. A meeting planner distributes the costs 58 incurred at the meeting level to the individual events in the meeting planning system based on factors such as attendance, a flat percentage per event, a dollar value per event, or other means. Using one of these factors, distributing meeting level costs 58 to individual events is easy for a meeting planner because the meeting planning system can do the work. However, before the meeting planning system can assign event level costs 58 to individual events, the meeting planner must enter the cost 58 of each item into the meeting planning system, which involves a considerable amount of data entry work since meetings often require a great many items. Therefore, in a preferred embodiment, meeting costs 58 are managed at the meeting level rather than the event level. Alternatively, the meeting planning system provides the ability to track costs 58 at the event level because the additional work used to input costs 58 at the event level enables the planner to track costs 58 for individual suppliers and produce reports for venues and suppliers, referred to as resumes, which a particular planner may require. Often such detailed information is lost year to year as planner responsibilities change. The planner uses the resume for purposes such as proof of signature for authorizing individual event orders and supplies, and to keep a head count for meal functions. Income 60 is tallied to provide a total income at the meeting level and to track income 60 for individual events that are required to be self-supporting. The event level cost 58 and income 60 information later becomes a source of history.

After a meeting is complete a meeting planner receives invoices 62 for the actual charges 64 for the products and services provided by the suppliers 32 for the meeting. The meeting planner then reconciles these invoices against the meeting planner's own records. In general, invoices 62 correspond to the supplier categories 28 and costs categories. Therefore, by entering the actual charges 64 into the meeting planning system, the meeting planning system can readily calculate and display the variance versus forecast 56 for each supplier 32, as an aid in the reconciliation process. For complex invoices 62 or invoices 62 the meeting planner has trouble reconciling, the meeting planner enters the quotes from RFPs 22 and actual charges 64 for individual products and services into the meeting planning system to calculate variances 56 on an item by item basis. But entering quotes and charges 64 for individual products and services is a laborious process that a meeting planner will want to avoid whenever possible.

If a meeting planner chooses, costs 58 and actual charges 64 for each item are broken down into greater detail and entered into the meeting planning system. Examples of cost 58 and actual charge 64 detail are; quantity, unit cost, tax, gratuity, and service charge. The meeting planning system calculates the following: detailed costs 58, actual charges 64, extended cost which is quantity times unit price, and total cost which is the sum of extended cost, tax, gratuity, and service charge. Entering detailed cost breakdowns into the meeting planning system is a laborious process that a meeting planner would typically not undertake unless the meeting planner received an electronic data feed from a supplier 32 or venue into the meeting planning system or the meeting planner needed to track a detailed cost 58 such as tax, or gratuity for a particular cost category.

Once the meeting planner has entered the actual charges 64 from suppliers 32 into the meeting planning system, the meeting planning system can calculate other variances 66 of interest to the planning organization and owning organization such as the variance versus budget 66 and the variance versus forecast 66 for the cost and income categories and for the meeting as a whole. These variances enable the owning organization to judge the financial success of the meeting and enable the planning organization to judge the financial performance of the meeting planners. This is another example of a tool, in this case the reconciling tool, contained in the meeting planning system that gives the meeting planners the incentive to enter information needed by an organization for other purposes.

FIG. 2B illustrates a sample budget detail interface which displays dynamic budget information in accordance with the present invention. On the budget detail interface, the meeting is identified 230, by name, number, dates and/or property where the meeting will be held. For a draft budget or forecast 54 (FIG. 2A), the property, location and dates may not yet be set for the meeting. In such a case, only a name or number may identify a meeting or hypothetical budgets may be set up for various suppliers or combinations of suppliers.

The example of a budget detail interface shown in FIG. 2B shows necessary resources divided by the category 234 which particular resource item falls under. Example categories are food & beverage, room rental, audio-visual equipment, amenities and entertainment, room setup, and miscellaneous categories. For each category 234, the planner can choose a particular supplier 236 for the resource. The user of the system can type in a particular supplier or import a supplier through the tracking system of the present invention to the budget interface. A means is provided on the interface to allow the planner to choose the entered supplier to be chosen for the budget. In the example shown, a select button 238 is shown. In addition, the budget shows a forecasted 240 cost for the particular resource from a particular supplier. As shown in the Food and Beverage line of the budget 232, when the select button 238 or other means is used, forecasted cost information is also selected for that supplier. The budget also has means to enter the actual cost 242 of a particular resource. When the actual costs are entered, the planner is able to reconcile 246 the actual costs with the forecasted costs. The planner can check off each resource as it is reconciled 246 after the meeting is over or the cost has been paid in full.

The planner also has the option of adding notes 244 for each resource. Notes may include information about the supplier, quantities to be ordered or reasons why the actual costs were smaller or larger than the forecasted costs. The notes may assist in the formulation of the budget or as explanations when costs are being reconciled.

Once a meeting planner has entered the actual charges 64 from suppliers 32 and income 60 into the meeting planning system, the meeting planning system can consolidate the meeting information 68 with information about other meetings enabling an organization to generate consolidated reports about all the organization's meetings. Reports are generated by a report generating unit of the meeting planning system, a computer program which instructs a computer to create reports or a method for generating reports.

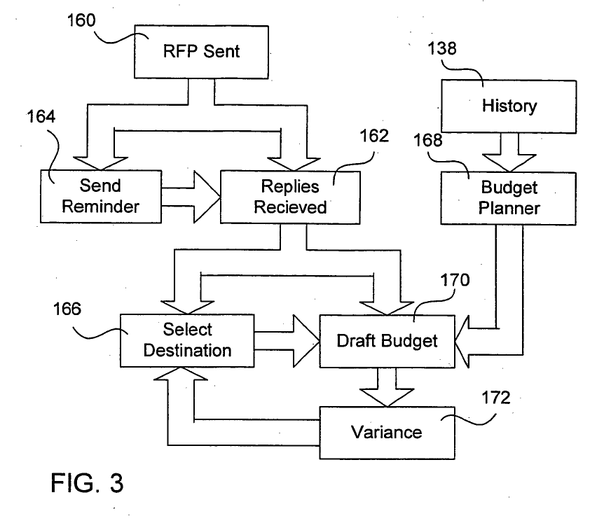

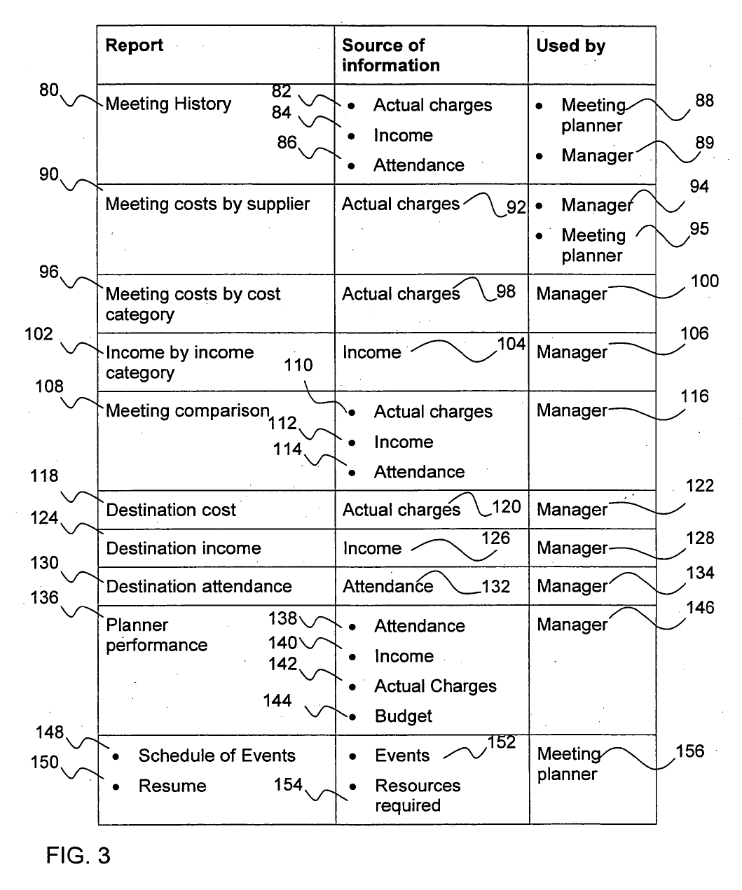

Each of the consolidated reports contains information collected by meeting planners in the course of using the meeting planning system to plan meetings for the meeting planner's organization. The meeting planning system retains the information collected by the meeting planners to enable the meeting planners' organization to produce the consolidated reports. Referring now to FIG. 3, consolidated reports will now be described and explained in detail with reference to FIG. 1A-2B. Each report provided in the meeting planning system may be filtered, sorted, and customized by meeting planners and other users using report generation tools and technology commercially available for customizing reports and contained in the meeting planning system. The meeting planning system exports the information in each reports in standard formats so the meeting information can be combined with other information and manipulated with other data management tools not contained in the meeting planning system.

One report generated from the meeting planning system is meeting history 38, 80. Meeting history 38, 80 is tabulated from actual charge data 64, 82 income data 60, 84 and attendance data 86 from registration 30 (FIG. 1A). A meeting planner 88 uses meeting history 38, 80 as a guide to project attendance, costs 58 and income 60 for future meetings. Meeting history 38, 80 is a valuable tool a meeting planner uses to demonstrate to a venue that the meeting will use the meeting space a meeting planner is requesting. A meeting planner uses meeting history 38, 80 to negotiate discounts from venues and suppliers 32 based on the volume of business a venue or supplier expects. A meeting planner uses meeting history 38, 80 to negotiate perks such as complimentary guest rooms, office or meeting space, waivers of service fees and other complimentary services from venues and similar perks from other suppliers 32. A meeting planner uses meeting history 38, 80, particularly attendance information, to promote a meeting to prospective sponsors and exhibitors. A manager 89 uses meeting history 38, 80 to project attendance, costs 58 and income 60 for large, individual, recurring meetings such as annual conventions, several years into the future to plan for the required internal and external resources.

Another report generated from the meeting planning system is an organization's meeting spending by supplier 90. The meeting spending by supplier report 90 totals the actual charges 92 for each venue and/or supplier for all an organization's meetings over a specific time period such as a year, quarter, month or other defined period of time. A manager 94 uses the meeting spending by supplier report 90 to identify its largest venues and suppliers to aid in selecting preferred suppliers. Consolidating venues and suppliers into a few preferred suppliers enables a manager to negotiate comprehensive contracts that cover all the organization's business with a supplier. A manager uses the meeting spending by supplier report 90 to negotiate reduced rates with venues and suppliers 32 since the manager now knows the total volume of business the manager's organization conducts with each supplier 32. A meeting planner 95 uses the spending by supplier report 90 to negotiate reduced rates with venues and suppliers 32 for individual meetings.

Another report generated from the meeting planning system is an organization's meeting spending by cost category 96. This meeting spending by cost category report 96 shows the trend in the total actual charges 64, 98 for each cost category for all an organization's meetings over time. Typically the trend in an organization's meeting charges 64, 98 is presented year on year. A manager 100 uses the meeting spending by cost category report 96 to identify cost categories where actual charges 64, 98 are growing faster than in other categories so the organization may introduce methods to control actual charges 64, 98 in the rapidly growing categories. Once an organization has introduced efforts to control actual charges 64, 98 in a category, a manager uses the meeting spending by cost category report 96 to monitor the effectiveness of the organization's cost control efforts. A manager also uses the meeting spending by cost category report 96 to negotiate preferred pricing with suppliers by showing a supplier the magnitude of the business the supplier will receive as a preferred supplier.

Another report generated using the present invention which is similar to the meeting spending by cost category report 96 is a meeting income by income category report 102. This report shows the trend in income 60, 104 for each income category for all an organization's meetings over time. Typically the trend is presented year on year. A manager 106 uses the meeting income by income category report to identify income categories where income 60 is declining or increasing faster than other categories. An organization may then introduce methods to address the declining income categories or direct more services and resources to the rapidly increasing income categories. A manager uses the meeting income by income category report 102 to monitor the effectiveness of the methods to address the rapidly changing income categories.

Another report generated from the meeting management system is a meeting comparison report 108 which compares information about similar meetings or series of meetings. A meeting comparison report tabulates and displays the actual charges 64, 110 in costs categories, income 60, 112 in income categories and attendance 114 from registration 30. A meeting comparison report 108 displays actual charges 64, 110 and income 60, 112 per attendee and per meeting planner. A meeting comparison report 108 enables a manager 116 to determine which meetings are meeting or failing to meet the organization's financial goals.

Another report generated from the meeting management system is a destination cost report 118. A destination cost report 118 tabulates and displays actual charges 64, 120 based on the destinations 20 where an organization holds meetings. A destination cost report 118 tabulates actual charges 64, 120 for any collection of meetings such as a series of meetings or all meetings in a particular time period. A manager 122 uses a destination cost report 118 to identify destinations where the organization incurs the largest actual charges 64, 120 so the manager can evaluate whether there are other more cost effective destinations the organization can use. A manager 122 also uses a destination cost report 118 to identify meetings that may be relocated to consolidate meetings at a single destination and negotiate lower rates from the suppliers 32 at that destination. A manager 122 views actual charges 64, 120 in the destination cost report 118 on a per attendee basis to determine how costs effect attendance or a per meeting planner basis to determine how cost effective the organization's meeting planners are.

Another report generated from the meeting planning system is a destination income report 124. A destination income report 124 tabulates and displays income 60, 126 based on the destinations where an organization holds meetings. A destination income report 124 tabulates income 60, 126 for any collection of meetings such as a series of meetings or all meetings in a particular time period. A manager 128 uses a destination income report 124 to identify destinations where the organization obtains the greatest and least incomes 60, 126 for consideration in relocating meetings from low income destinations to higher income destinations.

A report that is similar to a destination income report 124 generated from the meeting management system is a destination attendance report 130. A destination attendance report 130 tabulates and displays attendance 132 from registration 30 based on the destinations where an organization holds meetings. A destination attendance report 124 tabulates attendance for collections of meetings such as a series of meetings or all meetings in a particular time period. A manager 134 uses a destination attendance report 124 to identify destinations where the organization obtains the greatest and least attendance for consideration in relocating meetings from low attendance destinations to higher attendance destinations.

Another report generated from meeting information is a meeting planner performance report 136. A meeting planner performance report 136 tabulates attendance 138 trends, income 60, 140 and actual charges 64, 142 versus budget 50, 144 or other information about the meetings planned by a particular meeting planner. A manager 146 in an organization uses a meeting planner performance report 136 to compare a meeting planners meeting financial information to the organization's objectives, to the meeting planners personal performance objectives or to meeting planner performance reports 136 for other meeting planners. The meeting planner performance report 136 identifies aspects of meeting planning that require greater attention by a particular meeting planner. The meeting planner performance report compares established prices such as list, average, or preferred prices, to each planners actual charges 64, 142 as a measure of the valued added by each meeting planner or a meeting planning department as a whole. The meeting planner performance report also identifies aspects of meeting planning where a particular meeting planner is particularly skilled or has developed effective practices that will benefit other meeting planners in the meeting planner's organization.

Two reports required by a meeting planner 156 are a schedule of events 148 and a resume 150. A schedule of events is a chronological display of the events 152 for a meeting that were entered into the meeting planning system during the process of selecting a destination 20. A resume is similar to a schedule of events but it is expanded to include set up information and the resources required 34, 154 for each event. These two reports enable a meeting planner to organize a meeting. A schedule of events 148 is also provided to attendees while a resume 150 is provided to venues and suppliers.

Numerous other report formats may be generated from the meeting planning system to meet the particular needs of a meeting planner or organization. The reports described herein and other reports may be used by managers, planners or others. Some examples are a balance sheet for a meeting, an income statement for a meeting and reports of income or attendance by attendee demographics for a single meeting or collection of meetings. The content and format of these reports will depend on the specific information entered by the meeting planner into the meeting planning system and the particular needs of the user of the report.

In the foregoing discussion some of the interrelationships between the various steps in the meeting planning process were described but for the most part, the steps in the meeting planning system were presented as separate processes. In fact, many of the various other steps in the meeting planning process are interrelated. The meeting planning system compiles the information gathered by a meeting planner in the various steps in the meeting planning process enabling the meeting planner to use the information collected in later steps in the meeting planning process. One example from the foregoing discussion is the definition of events 14 that are later used in registration 30, 36 and in the process of selecting resources required 34 for a meeting. Some additional examples where the meeting planning system stores information collected in one stage of the meeting planning process that is used in another stage in the meeting planning process will now be described and explained in detail.

Online registration enables a meeting planner to transfer the task of entering an attendee's registration in the meeting planning system. There are several incentives to encourage an attendee to register on line including; a single place for an attendee to register 30 for the meeting, events 36, housing 40 and air transportation 42 and to pay for these services as a single transaction, the ability of the attendee to easily review and change a registration at a later time, the ability of the attendee to produce a single travel itinerary with all the attendee's confirmation numbers and the ability of the attendee to generate an expense report for the meeting. If an attendee is associated with a large client of the organization providing the meeting planning system an attendee's expense report is generated in the format of the attendee's organization or submitted electronically to the attendee's organization.

In addition to tracking registrations 30 for a meeting, it is desirable for a meeting planner to track registrations for individual events 36. If a meeting planner knows how many attendees registered for an event 36, the meeting planner can adjust the room setup, catering order, move an event to a more suitably size room or cancel the event as appropriate. Adjusting the foregoing aspects of an event reduces meeting costs if attendance falls below expectations and improves service to attendees if attendance is above expectations. The meeting planning system tracks and compares registrations for events 36 to expected attendance and alerts a meeting planner if event registrations 36 vary by more than a threshold amount from expected attendance through either a report the meeting planner runs or an warning message. However, an attendee is unlikely to register for events 36, especially if there are a large number of events to choose from, unless a meeting planner provides an incentive to the attendee. One incentive meeting planners use to encourage registrations for events 36 is to require attendees to register in order to attend, an action that tends to discourage attendance for events 36. The meeting planning system provides better incentives to encourage an attendee to register for events 36. The meeting planning system permits an attendee to indicate all the events the attendee wants to attend. Once the attendee selects events the meeting planning system displays any scheduling conflicts between the events the attendee selected and enables the attendee to designate his preferred event for each time period. The attendee's preferred events are treated as the events the attendee is registered for. Once the attendee has selected preferred events the meeting planning system produces a personalized schedule of the events that the attendee plans to attend including the locations, times and any amenities provided for the event. An attendee may, at any time, produce an updated report that will display any cancellations or other changes in the events the attendee plans to attend. An attendee may also change his event schedule at any time and the change will be reflected in the report of event attendance the meeting planner sees.

Often a meeting planner contracts with the host venue to pay a cancellation penalty if the meeting planner cancels the meeting. If a meeting planner must cancel a meeting the meeting planner can post an alert message in the meeting planning system that other meeting planners in the owning organization or planning organization will see alerting other meeting planners to schedule a meeting at the venue during the time scheduled for the original meeting so the owning organization can avoid paying the cancellation fee.

The foregoing meeting planning system may be provided by an owning organization, a planning organization, a supplier organization or by a company that owns or operates venues. The meeting planning system enables each of these types of organization to report costs by supplier and supplier category as described in the foregoing discussion. The meeting planning system also enables planning organizations, suppliers and venue companies to report costs and income by customer. A planning organization reports actual charges 64 and income for all meetings it plans for its customers, the owning organizations. A supplier or venue company reports actual charges 64 and income 60 for all meetings it services for its customers, the meeting planners' organizations. The actual charges 64 and income 60 reports available to a planning organization or supplier from the meeting planning system enable the planning organization or supplier to identify its largest and most profitable customers to provide superior service to these valuable customers.

The foregoing disclosure is illustrative of the present invention and is not to be construed as limiting thereof. Although one or more embodiments of the invention have been described, persons of ordinary skill in the art will readily appreciate that numerous modifications could be made without departing from the scope and spirit of the disclosed invention. As such, it should be understood that all such modifications are intended to be included within the scope of this invention as defined in the claims. Within the claims, means-plus-function language is intended to cover the structures described in the present application as performing the recited function, and not only structural equivalents but also equivalent structures. The written description and drawings illustrate the present invention and are not to be construed as limited to the specific embodiments disclosed. Modifications to the disclosed embodiments, as well as other embodiments, are included within the scope of the claims. The present invention is defined by the following claims, including equivalents thereof.

1. A computer system for use in managing the planning of meetings, said computer system comprising:
at least one input device;
at least one display;
at least one processor;
means for receiving meeting identification data from a planner through said input device;
means for receiving meeting scheduling data;
means for receiving resource data for resources required for a meeting;
means for generating a request for proposal to send to a supplier of said resource;
means for receiving proposal data from said supplier;
means for tracking said request for proposals and said proposal data from said supplier;
means for creating a budget for said meeting;
means for receiving financial data for said meeting;
means for receiving registration data for said meeting;
means for storing data, said data comprising at least one member of the group consisting of meeting identification data, meeting scheduling data, resource data, request for proposal, proposal data, budget, and registration data; and
means for generating a report based on said stored data.

2. The system as recited in claim 1 wherein said means for receiving registration data is coupled to said input device, and wherein said registration data is entered into said registration unit through said input device.

3. The system as recited in claim 2 further comprising a link to a global informational network.

4. The system as recited in claim 3 wherein said means for receiving registration data comprises an input device coupled to said link to said global informational network.

5. The system as recited in claim 1 further comprising a link to a global informational network.

6. The system as recited in claim 1 wherein said dynamic financial data comprises at least one member of the group consisting of forecasted costs, actual costs, forecasted income and actual income.

7. The system as recited in claim 1 further comprising:
a database containing information about suppliers for said meeting; and
means for searching said database.

8. The system as recited in claim 1 further comprising means for consolidating said stored data from two or more meetings.

9. The system as recited in claim 8 wherein said means for generating a report based on said stored data generates at least one report containing said consolidated data.

10. The system as recited in claim 1 wherein said means for generating a report based on said stored data generates at least one report containing financial data categorized according to one or more of the following supplier categories: food and beverage, meeting room rental, guest room rental, audio-visual equipment rental, equipment rental, printing, advertising, air travel, car rental, insurance, and staffing.

11. The system as recited in claim 10 wherein said financial data comprises meeting spending data for an organization.

12. The system as recited in claim 1 wherein said meeting scheduling data comprises information regarding cancelled meetings.

13. The system as recited in claim 12 wherein said means for generating a report based on said stored data generates a report comprising at least one member of the group consisting of: guest rooms for said cancelled meetings, meeting space for said cancelled meetings, transportation tickets for said cancelled meetings, and event tickets for said cancelled meetings.

14. The system as recited in claim 1 further comprising: a search unit, wherein said
means for searching said stored data.

15. A method for managing the planning of meetings, said method comprising:
receiving scheduling data for a meeting;
storing said scheduling data;
creating a budget for said meeting;
storing said budget;
receiving data related to a required resource for said meeting;
storing said data related to said required resource;
generating a request for proposal for provision of said required resource;
storing said request for proposal;
receiving a proposal from a supplier to provide said required resource;
storing said proposal;
importing data from said proposal into said budget;
collecting financial data for said meeting;
storing said financial data;
importing said financial data into said budget; and
reconciling said financial data, said proposal data and said budget.

16. The method as recited in claim 15 wherein said financial data comprises at least one member selected from the group consisting of: actual costs, forecasted costs, forecasted income, and actual income.

17. The method as recited in claim 15 further comprising:
generating a report summarizing selected data related to said meeting, said data selected from the group consisting of meeting history, total meeting costs, total meeting income, meeting costs by category, meeting income by category, meeting costs by supplier, total actual meeting costs, total actual meeting income, actual meeting income by category, attendance, schedule of events, destination costs, and destination income.

18. The method as recited in claim 15 wherein said scheduling data comprises at least one member of the group consisting of meeting dates, event dates, meeting time of day, and event time of day.

19. The method as recited in claim 15 wherein said budget data comprises at least one member of the group consisting of forecasted costs, actual costs, forecasted income and actual income.

20. A method as recited in claim 15 further comprising:
generating a report containing financial data arranged into one or more categories selected from the group consisting of food and beverage, meeting room rental, guest room rental, audio-visual equipment rental, equipment renatal, printing, advertising, air travel, car rental, insurance, and staffing;
negotiating reduced pricing with one or more suppliers in one or more of said supplier categories based on said financial data;
negotiating for the provision of complimentary goods and services from one or more suppliers in one or more of said supplier categories based on said financial data with one or more suppliers in one or more of said supplier categories; and
comparing said financial data to said budget.

21. The method as recited in claim 20 wherein said financial data comprises meeting spending data for an organization.

22. The method as recited in claim 15 further comprising:
receiving cancellation data for a meeting; and
storing said cancellation data.

23. The method as recited in claim 15 further comprising:
consolidating all stored data.

24. A computer program product comprising:
a computer usable medium having computer readable code embodied therein for managing the planning of a meeting;
a computer readable program code configured to cause a computer to receive input that defines parameters for a meeting;
a computer usable medium having computer readable code embodied therein for creating a budget for a meeting;
a computer readable program code configured to cause a computer to receive input that defines a required resource for a meeting;
a computer readable program code configured to cause a computer to generate a request for a proposal from a supplier to provide said required resource for a meeting;
a computer readable program code configured to cause a computer to receive data from a proposal from a supplier to provide said required resource for a meeting;
a computer readable program code configured to cause a computer to generate a forecast of costs for said required resource for a meeting;
a computer readable program code configured to cause a computer to receive input that indicates an actual cost from a supplier for said required resource for a meeting;
a computer readable program code configured to cause a computer to compare said budget, said forecast of costs of said required resource and said actual cost for said required resource; and
a computer readable program code configured to cause a computer to store at least one member of the group consisting of input defining parameters for a meeting, input that defines a required resource for a meeting, a request for proposal for a required resource for a meeting, a proposal from a supplier to provide a required resource for a meeting, budget, input indicating an forecast cost for said required resource for a meeting, input indicating an actual cost for said required resource for a meeting, and comparisons of a budget, forecast costs and actual costs for a required resource for a meeting.

25. The computer program product as recited in claim 24 further comprising:
a computer readable program code configured to cause a computer to generate a report containing a set of dynamic meeting data selected from the group consisting of: meeting history, total meeting costs, total meeting income, meeting costs by category, meeting income by category, meeting costs by supplier, total actual meeting costs, total actual meeting income, actual meeting income by category, attendance, schedule of events, destination costs, and destination income.

26. The computer program product as recited in claim 24 further comprising:
a computer readable program code configured to cause a computer to produce consolidated data from said stored data from two or more said meetings

27. The computer program product as recited in claim 26 further comprising:
a computer readable program code configured to cause a computer to generate at least one report containing said consolidated data.

28. The computer program product as recited in claim 24 further comprising:
a computer readable program code configured to cause a computer to generate at least one report containing financial data categorized according to one or more of the following supplier categories: food and beverage, meeting room rental, guest room rental, audio-visual equipment rental, equipment rental, printing, advertising, air travel, car rental, insurance, and staffing.

29. The computer program product as recited in claim 24 further comprising:
a computer readable program code configured to cause a computer to connect to at least one remote computer.
